(19) United States
(12) Patent Application Publication
(10) Pub. No.: US 2026/0171079 A1
(43) Pub. Date: Jun. 18, 2026

(54) TECHNIQUES FOR SPEECH ENHANCEMENT

(71) Applicant: Sonos, Inc., Goleta, CA (US)

(72) Inventors: Matthew Benatan, Stockport (GB); Raffaele Tavarone, Paris (FR)

(73) Assignee: Sonos, Inc., Goleta, CA (US)

(21) Appl. No.: 19/421,693

(22) Filed: Dec. 16, 2025

Related U.S. Application Data
(60) Provisional application No. 63/735,030, filed on Dec. 17, 2024.

(51) Int. Cl. G10L 15/08; G10L 15/22

(52) U.S. Cl. CPC G10L 15/08; G10L 15/22; G10L 2015/088

(57) ABSTRACT

Example systems and methods for recognizing voice command interactions without reliance on a wake word include analyzing an audio data portion of an incoming stream of media content to detect a vocalization within, and, responsive to the detecting, communicating a speech signal, where, in absence of the speech signal, at least one incoming stream of sound signals captured by at least one microphone is evaluated to detect vocalization of one of a set of commands for controlling a playback device.

### RELATED APPLICATIONS

The present disclosure claims priority to U.S. Provisional Patent Application Ser. No. 63/735,030 entitled “Techniques for Speech Enhancement” and filed Dec. 17, 2024, the content of which is hereby incorporated by reference in its entirety.

### FIELD OF THE DISCLOSURE

The present disclosure is related to consumer goods and, more particularly, to methods, systems, products, aspects, services, and other elements directed to media playback or some aspect thereof.

### BACKGROUND

Options for accessing and listening to digital audio in an out-loud setting were limited until in 2002, when Sonos, Inc. began development of a new type of playback system. Sonos then filed one of its first patent applications in 2003, entitled “Method for Synchronizing Audio Playback between Multiple Networked Devices,” and began offering its first media playback systems for sale in 2005. The SONOS Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Aspects, and advantages of the presently disclosed technology may be better understood with regard to the following description, appended claims, and accompanying drawings, as listed below. A person skilled in the relevant art will understand that the elements shown in the drawings are for purposes of illustrations, and variations, including different and/or additional elements and arrangements thereof, are possible.

FIG. 1A is a partial cutaway view of an environment having an example media playback system configured in accordance with aspects of the disclosed technology.

FIG. 1B is a schematic diagram of the media playback system of FIG. 1A and one or more networks.

FIG. 1C is a block diagram of an example playback device.

FIG. 1D is a block diagram of an example playback device.

FIG. 1E is a block diagram of an example bonded playback device.

FIG. 1F is a block diagram of an example network microphone device.

FIG. 1G is a block diagram of an example playback device.

FIG. 1H is a partial schematic diagram of an example control device.

FIG. 1I through FIG. 1L are schematic diagrams of example corresponding media playback system zones according to aspects of the disclosed technology.

FIG. 1M is a schematic diagram of example media playback system areas according to aspects of the disclosed technology.

FIG. 2 is a block diagram of an example system and playback device configured for wakewordless recognition of command terms.

FIG. 3A illustrates a flow chart of an example method for automatically flagging speech content within an audio portion of an incoming stream of media content.

FIG. 3B illustrates a flow diagram of an example method for switching to wakewordless command recognition based on whether an audio portion of an incoming stream of media content contains speech content.

FIG. 4 is a flow diagram of an example process for dividing audio content captured by a microphone between capture of media playback and vocalizations within a vicinity of the media playback.

FIG. 5A and FIG. 5B illustrate a flow chart of an example method for recognizing voice command interactions of a user of a playback device without reliance on a wake word.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Embodiments described herein relate to audio processing for wakewordless command recognition by a networked microphone device (“NMD”) included in or in communication with a playback device configured for broadcasting an audio portion of media content to the vicinity of the networked microphone device. The NMD, for example, may enable voice command capability for the playback device. A user may request processing of commands issued to the playback device, in some implementations, using a voice assistant service (VAS) by prefacing their voice input with a specific nonce wake word (e.g., word or brief phrase) for that VAS. In some illustrative examples, a user might speak the wake word “Alexa” to invoke the cloud-based AMAZON VAS, “Ok, Google” to invoke the cloud-based GOOGLE VAS, “Hey, Siri” to invoke the cloud-based APPLE VAS, or “Hey, Sonos” to invoke a VAS offered by SONOS.

In practice, a wake word is used to “wake up” a particular VAS to interpret the intent of voice input in detected sound. Under this paradigm, when performing voice processing, the VAS only needs to be able to detect a wake word in a voice input—the heavy-lifting of voice processing (e.g., spoken language understanding) may be offloaded to a natural language processing unit, either locally or, with many services, in the cloud.

In some implementations, the NMD is configured to support two or more voice assistant services, such as both the APPLE VAS (e.g., to communicate with the APPLE Music and/or APPLE TV services) and the SONOS VAS. To identify whether sound detected by the NMD contains a voice input that includes a particular wake word, NMDs often utilize a wake word engine, which is typically onboard the NMD. The wake word engine may be configured to identify (e.g., “spot” or “detect”) a particular wake word in an audio signal recorded by the NMD using one or more identification processes, which may include pattern recognition trained to detect the frequency and/or time domain patterns that speaking the wake word creates. When the wake word engine detects a wake word in recorded audio, the NMD may determine that a wake word event (e.g., a “wake word trigger”) has occurred, which indicates that the NMD has detected sound that includes a potential voice input. The occurrence of the wake word event typically causes the NMD to perform additional processes involving the detected sound. With a VAS wake word engine, these additional processes may include extracting detected-sound data from a buffer, among other possible additional processes, such as outputting an alert (e.g., an audible chime and/or a light indicator) indicating that a wake word has been identified. Extracting the detected sound may include reading out and packaging a stream of the detected-sound according to a particular format and transmitting the packaged sound-data to an appropriate VAS for interpretation.

In turn, in some implementations, the VAS corresponding to the wake word that was identified by the wake word engine receives the transmitted sound data from the NMD over a communication network. A VAS traditionally takes the form of a remote service implemented using one or more cloud servers configured to process voice inputs (e.g., AMAZON's ALEXA, APPLE's SIRI, MICROSOFT's CORTANA, GOOGLE'S ASSISTANT, etc.). In some instances, certain components and functionality of the VAS may be distributed across local and remote devices.

When a VAS receives detected-sound data, the VAS processes this data, which involves identifying the voice input and determining intent of words captured in the voice input. The VAS may then provide a response back to the NMD with some instruction according to the determined intent. Based on that instruction, the NMD may cause one or more smart devices to perform an action. For example, in accordance with an instruction from a VAS, an NMD may cause a playback device to play a particular song or pause a currently playing movie. In another example, responsive to the instruction from the VAS, the NMD may cause an illumination device to turn on/off.

One challenge with traditional wake word engines is that they can be prone to false positives caused by “false wake word” triggers. A false positive in the NMD context generally refers to detected sound input that erroneously invokes a VAS. With a VAS wake-work engine, a false positive may invoke the VAS, even though there is no user actually intending to speak a wake word to the NMD. For example, a false positive can occur when a wake word engine identifies a wake word in detected sound from audio (e.g., music, a podcast, TV, etc.) playing in the environment of the NMD. This output audio may be playing from a playback device in the vicinity of the NMD or by the NMD itself. For instance, when the audio of a commercial advertising AMAZON's ALEXA service is output in the vicinity of the NMD, the word “Alexa” in the commercial may trigger a false positive. A word or phrase in output audio that causes a false positive may be referred to herein as a “false wake word.” In another example, words that are phonetically similar to a service's wake word may cause false positives. For example, when the audio of a commercial advertising LEXUS® automobiles is output in the vicinity of the NMD, the word “Lexus” may be a false wake word that causes a false positive because this word is phonetically similar to “Alexa.” As other examples, false positives may occur when a person speaks a VAS wake word or phonetically similar word in conversation.

The occurrences of false positives are undesirable, as they may cause the NMD to consume additional resources or interrupt audio playback, among other possible negative consequences. Some NMDs may avoid false positives by requiring a button press to invoke the VAS, such as on the AMAZON FIRE TV remote or the APPLE TV remote. In practice, the impact of a false positive generated by a VAS wake word engine is often partially mitigated by the VAS processing the detected-sound data and determining that the detected-sound data does not include a recognizable voice input (e.g., an expected command term or phrase).

In contrast to relying on a VAS wake word engine, in one aspect, the present disclosure relates to analyzing an audio data portion of an incoming stream of media content to detect speech content and, responsive to whether or not speech content is detected, selecting a corresponding analysis technique for identifying user commands in microphone-captured sound.

In some embodiments, the analysis techniques include deactivating detection of vocalizations during periods of time when an audio portion of the streaming media content is determined to contain a high quantity of speech content. For example, because the media content being digested by the user(s) of a playback device has a strong likelihood of being in high competition with the user's voice, this may increase the likelihood of a false positive when analyzing a sound stream captured by one or more microphones for voice commands. By deactivating detection during periods of time of high competition, systems and methods employing this technique may provide a better user experience by avoiding interruption of the streaming media content due to falsely identifying a wake word or command term.

The analysis techniques, in some embodiments, include activating wakewordless command identification during periods of time when the audio portion of the streaming media content is determined to lack speech content. Because it is unlikely that vocalizations captured within the vicinity of the broadcast of the streaming media content include speech broadcast by the playback device, for example, systems and methods employing this technique may proceed with natural language processing of the sound stream to identify any command term (or wake word, in certain implementations) with high confidence that the vocalizations came from a user of the playback device.

In some embodiments, the analysis techniques include switching from a wake word triggered mode during times where the streaming media content is broadcasting speech content to a wakewordless analysis mode during times where the streaming media content lacks speech content. Detection of a wake word, for example, may increase confidence of recognition of an actual command term during periods of time where there is a likelihood of competition between vocalizations originating within the streaming media content and vocalizations originating within the vicinity of playback of the streaming media content.

The analysis techniques, in some embodiments, include, during periods of time when the streaming media content includes a speech portion, differentiating between the speech portion of the streaming media content and other vocalizations captured by a microphone within the vicinity of playback in a sound stream. For example, methods and systems described herein may selectively remove or suppress a portion of the sound stream captured within the vicinity of playback of streaming media content determined to match speech content of the audio portion of the streaming media content. In this manner, certain systems and methods described herein may increase confidence in detection of command terms (or a wake word) by distilling vocalizations originating outside of the playback of streaming media content.

In one aspect, the present disclosure relates to extracting a speech audio portion of an audio signal stream and analyzing an incoming sound stream captured by one or more microphones in view of the speech audio portion to differentiate between broadcast media content and words spoken within a vicinity of the broadcast to improve voice assistant services'accuracy in identifying user commands.

In some embodiments, extracting the speech audio portion includes identifying from streaming media content, speech audio data through frame-by-frame analysis of an audio portion of the streaming media content. Identifying the speech audio data may include developing, from the speech audio data, a speech mask for application to the sound stream captured by the microphone(s). The speech mask may be used to remove a portion of the sound stream matching speech frequenc(ies) detected within a given frame of the audio portion of the streaming media content.

In some embodiments, extracting the speech audio portion includes applying one or more machine learning processes to detect the speech audio data within the audio portion of the streaming media content. For example, certain systems and methods described herein employ at least one parametric machine learning model configured to dynamically differentiate over time between speech audio segments and non-speech audio segments within the audio data portion of the incoming stream of media content. The at least one parametric machine learning model, for example, may be configured to output a likelihood of speech content within a given frame of the audio portion of the streaming media content. The speech audio portion may be extracted responsive to the at least one parametric machine learning model indicating at least a threshold likelihood of speech content within the streaming media content.

While some examples described herein may refer to functions performed by given actors such as “users,” “listeners,” and/or other entities, it should be understood that such references are for purposes of explanation only. The claims should not be interpreted to require action by any such example actor unless explicitly required by the language of the claims themselves.

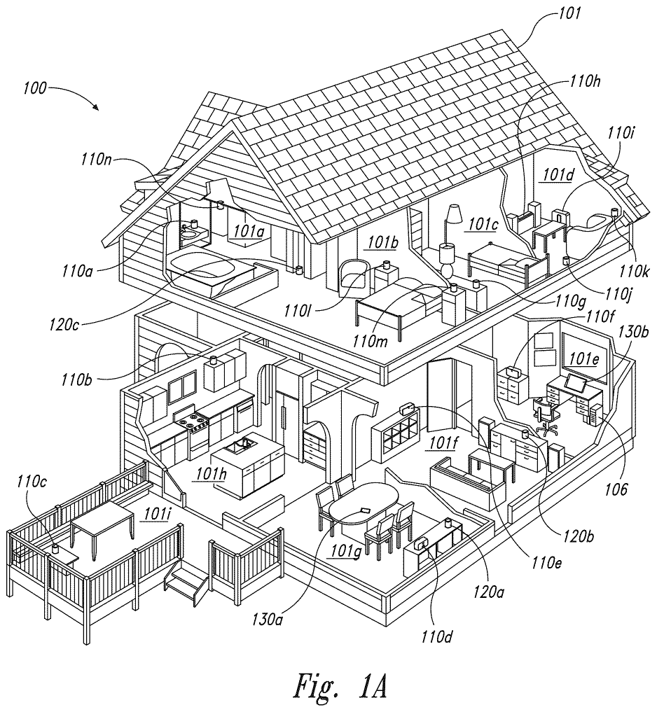

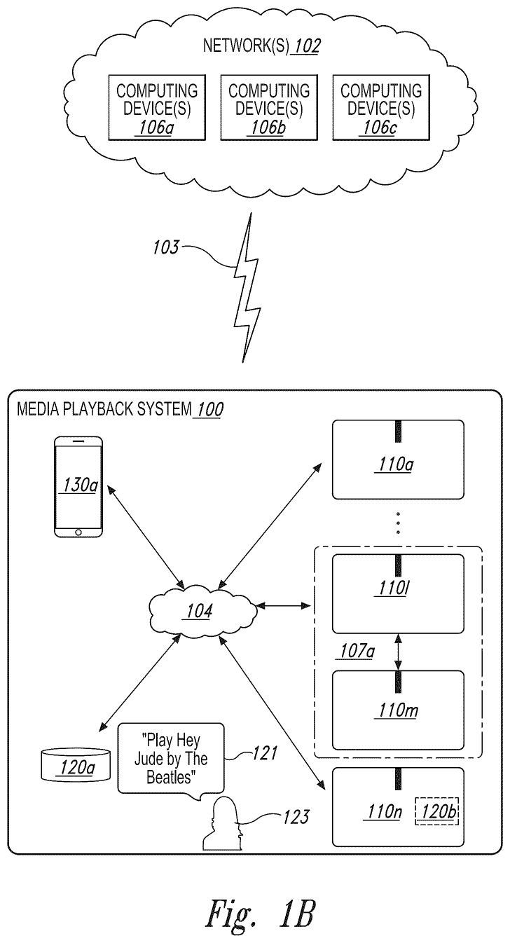

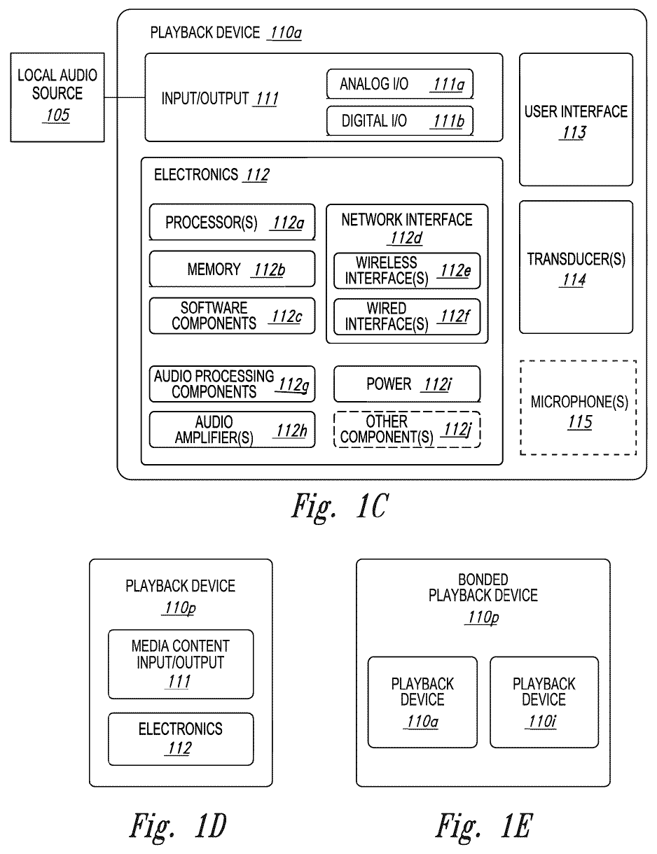

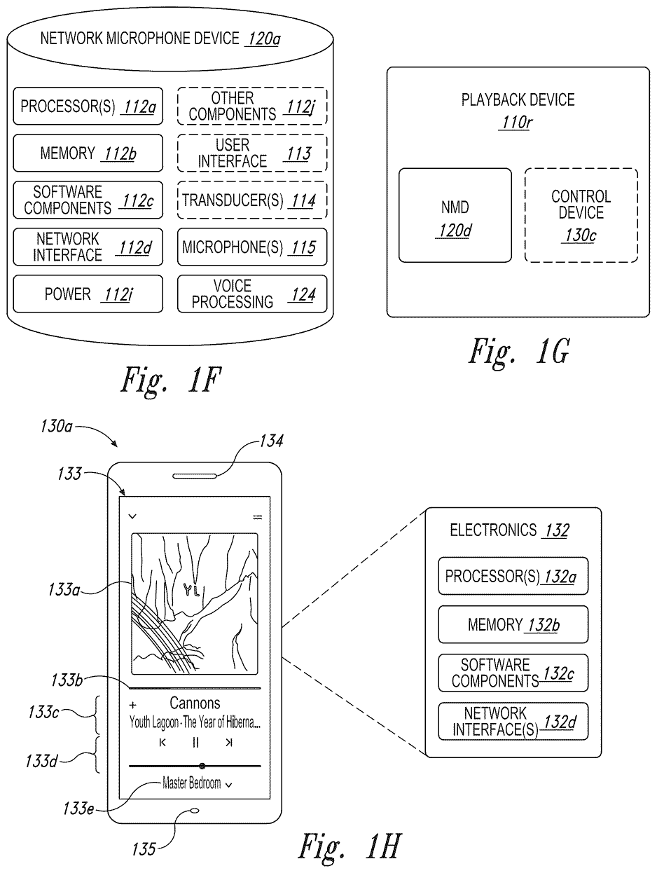

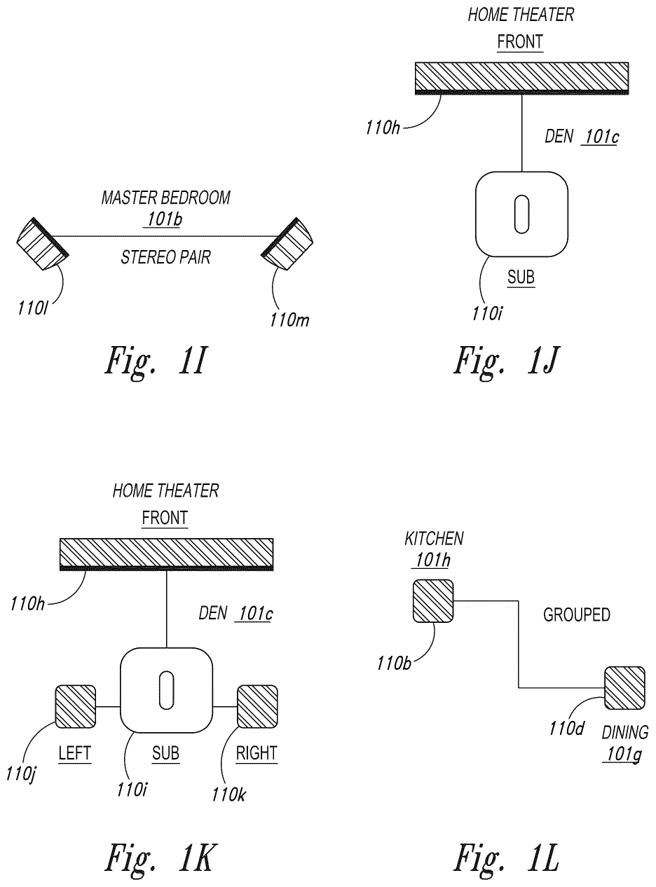

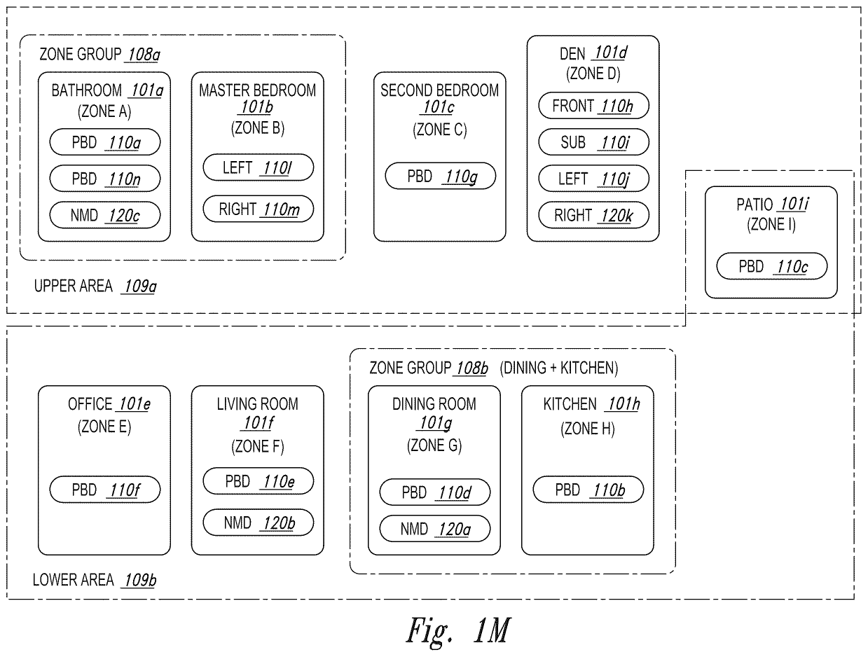

In the Figures, identical reference numbers identify generally similar, and/or identical, elements. To facilitate the discussion of any particular element, the most significant digit or digits of a reference number refers to the figure in which that element is first introduced. For example, element 110a is first introduced and discussed with reference to FIG. 1A. Many of the details, dimensions, angles, and other features shown in the Figures are merely illustrative of particular embodiments of the disclosed technology. Accordingly, other embodiments can have other details, dimensions, angles, and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system (MPS) 100 distributed in an environment 101 (e.g., a house). In the illustrated embodiment of FIG. 1A, the environment 101 includes a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane, etc.), multiple environments (e.g., a combination of home and vehicle environments), and/or another suitable environment where multi-zone audio may be desirable.

Within the rooms and spaces of the environment 101, the MPS 100 includes one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can have one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. A stand-alone NMD 120 may omit components and/or functionality that is typically included in a playback device 110, such as a speaker and/or related electronics. For instance, in such cases, a stand-alone NMD may not produce audio output or may produce limited audio output. In other embodiments, an NMD is incorporated into a playback device (or vice versa). A playback device 110 that includes components and functionality of an NMD 120 may be referred to as being “NMD-equipped.” Examples of playback devices 110 and NMDs 120 are described further below.

The term “control device” can generally refer to a network device configured to perform functions relevant to facilitating user access, control, and/or configuration of the media playback system 100. Examples of control devices are described further below.

In some examples, one or more of the various playback devices 110 may be configured as portable playback devices, while others may be configured as stationary playback devices. For example, certain playback devices 110 may include an internal power source (e.g., a rechargeable battery) that allows the playback device to operate without being physically connected to a mains electrical outlet or the like. In this regard, such a playback device may be referred to herein as a “portable playback device.” On the other hand, playback devices that are configured to rely on power from a mains electrical outlet or the like may be referred to herein as “stationary playback devices,” although such devices may in fact be moved around a home or other environment. In practice, a person might often take a portable playback device to and from a home or other environment in which one or more stationary playback devices remain.

Each of the playback devices 110 is configured to receive audio signals or data from one or more media sources (e.g., one or more remote servers, one or more local devices, etc.) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation, etc.). In some embodiments, for example, the media playback system 100 is configured to play back audio from a first playback device (e.g., the playback device 110a) in synchrony with a second playback device (e.g., the playback device 110b). Interactions between the playback devices 110, NMDs 120, and/or control devices 130 of the media playback system 100 configured in accordance with the various embodiments of the disclosure are described in greater detail below with respect to FIGS. 1B-1M.

The media playback system 100 can include one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the second bedroom 101c, the office 101e, the living room 101f, the dining room 101g, the kitchen 101h, and the outdoor patio 101i each include one playback device 110, and the master bathroom 101a, the master bedroom 101b, and the den 101d include a collection of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-k can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B, 1E, and 1I-M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can include, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication networks, and/or other suitable data transmission protocol networks), etc. The cloud network 102 is configured to deliver media content (e.g., audio content, video content, photographs, social media content, etc.) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 includes computing devices 106 (identified separately as a first computing device 106a, a second computing device 106b, and a third computing device 106c). The computing devices 106 can include individual computers or servers, such as, for example, a media streaming service server storing audio and/or other media content, a voice service server, a social media server, a media playback system control server, etc. In some embodiments, one or more of the computing devices 106 include modules of a single computer or server. In certain embodiments, one or more of the computing devices 106 include one or more modules, computers, and/or servers. Moreover, while the cloud network 102 is described above in the context of a single cloud network, in some embodiments the cloud network 102 includes a collection of cloud networks including communicatively coupled computing devices. Furthermore, while the cloud network 102 is shown in FIG. 1B as having three of the computing devices 106, in some embodiments, the cloud network 102 has fewer (or more than) three computing devices 106.

The media playback system 100 is configured to receive media content from the networks 102 via the links 103. The received media content can include, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WI-FI network, a BLUETOOTH network, a Z-WAVE network, a ZIGBEE network, and/or other suitable wireless communication protocol network) and/or a wired network (e.g., a network such as Ethernet, Universal Serial Bus (USB), and/or another suitable wired communication). As those of ordinary skill in the art will appreciate, as used herein, “WI-FI” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some embodiments, the network 104 includes a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 includes an existing household or commercial facility communication network (e.g., a household or commercial facility WI-FI network). In some embodiments, the links 103 and the network 104 include one or more of the same networks. In some aspects, for example, the links 103 and the network 104 may include a telecommunication network (e.g., an LTE network, a 5G network, etc.). Moreover, in some embodiments, the media playback system 100 is implemented without the network 104, and devices including the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud servers that host cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database including metadata (e.g., title, artist, album, track length, etc.) and other associated information (e.g., URIs, URLs, etc.) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m form a group 107a. The playback devices 110l and 110m can be positioned in different rooms and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a includes a bonded zone in which the playback devices 110l and 110m have left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1I through 1M.

The media playback system 100 includes the NMDs 120a and 120b, each including one or more microphones configured to receive voice utterances from a user. In the illustrated embodiment of FIG. 1B, the NMD 120a is a standalone device and the NMD 120b is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c includes one or more modules and/or servers of a VAS (e.g., a VAS operated by one or more of SONOS, AMAZON, GOOGLE, APPLE, MICROSOFT, etc.). The computing device 106c can receive the voice input data from the NMD 120a via the network 104 and the links 103.

In response to receiving the voice input data, the computing device 106c processes the voice input data (e.g., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

b. Suitable Playback Devices

FIG. 1C is a block diagram of the playback device 110a including an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection including, for example, an auto-detecting 3.5 mm audio line-in connection. In some embodiments, the digital I/O 111b includes a Sony/Philips Digital Interface Format (S/PDIF) communication interface and/or cable and/or a Toshiba Link (TOSLINK) cable. In some embodiments, the digital I/O 111b includes a High-Definition Multimedia Interface (HDMI) interface and/or cable. In some embodiments, the digital I/O 111b includes one or more wireless communication links such as, in some examples, a radio frequency (RF), infrared, WI-FI, BLUETOOTH, or another suitable communication link. In certain embodiments, the analog I/O 111a and the digital I/O 111b includes interfaces (e.g., ports, plugs, jacks, etc.) configured to receive connectors of cables transmitting analog and digital signals, respectively, without necessarily including cables.

The playback device 110a, for example, can receive media content (e.g., audio content including music and/or other sounds) from a local audio source 105 via the input/output 111 (e.g., a cable, a wire, a PAN, a BLUETOOTH connection, an ad hoc wired or wireless communication network, and/or another suitable communication link). The local audio source 105 can be, in some examples, a mobile device (e.g., a smartphone, a tablet, a laptop computer, etc.) or another suitable audio component (e.g., a television, a desktop computer, an amplifier, a phonograph (such as n LP turntable), a Blu-ray player, a memory storing digital media files, etc.). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 include the local audio source 105. In other embodiments, however, the media playback system omits the local audio source 105 altogether. In some embodiments, the playback device 110a does not include an input/output 111 and receives all audio content via the network 104.

In some embodiments, the playback device 110a further includes electronics 112, a user interface 113 (e.g., one or more buttons, knobs, dials, touch-sensitive surfaces, displays, touchscreens, etc.), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B), amplify the received audio, and output the amplified audio for playback via one or more of the transducers 114. In some embodiments, the playback device 110a optionally includes one or more microphones 115 (e.g., a single microphone, a collection of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 include one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases, etc.).

The processors 112a can include clock-driven computing component(s) configured to process data, and the memory 112b can include a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone, etc.).

The processors 112a can be further configured to perform operations causing the playback device 110a to synchronize playback of audio content with another of the one or more playback devices 110. As those of ordinary skill in the art will appreciate, during synchronous playback of audio content on a collection of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can include one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds, etc.) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) including digital packet data including an Internet Protocol (IP)-based source address and/or an IP-based destination address. The network interface 112d can parse the digital packet data such that the electronics 112 properly receive and process the data destined for the playback device 110a.

In the illustrated embodiment of FIG. 1C, the network interface 112d includes one or more wireless interfaces 112e (referred to hereinafter as “the wireless interface 112e”). The wireless interface 112e (e.g., a suitable interface having one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WI-FI, BLUETOOTH, LTE, etc.). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 exclude the network interface 112d altogether and transmit and receive media content and/or other data via another communication path (e.g., the input/output 111).

The audio components 112g are configured to process and/or filter data including media content received by the electronics 112 (e.g., via the input/output 111 and/or the network interface 112d) to produce output audio signals. In some embodiments, the audio processing components 112g include, for example, one or more digital-to-analog converters (DACs), audio preprocessing components, audio enhancement components, digital signal processors (DSPs), and/or other suitable audio processing components, modules, circuits, etc. In certain embodiments, one or more of the audio processing components 112g can include one or more subcomponents of the processors 112a. In some embodiments, the electronics 112 omit the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can include electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers 112h include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G amplifiers, class H amplifiers, and/or another suitable type of power amplifier). In certain embodiments, the amplifiers 112h include a suitable combination of two or more of the foregoing types of power amplifiers. Moreover, in some embodiments, individual ones of the amplifiers 112h correspond to individual ones of the transducers 114. In other embodiments, however, the electronics 112 include a single one of the amplifiers 112h configured to output amplified audio signals to the transducers 114. In some other embodiments, the electronics 112 omit the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 represent a single transducer. In other embodiments, however, the transducers 114 include multiple audio transducers. In some embodiments, the transducers 114 include more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 include transducers that do not adhere to the foregoing frequency ranges. For example, one of the transducers 114 may include a mid-woofer transducer configured to output sound at frequencies between about 200 Hz and about 5 kHz.

By way of illustration, Sonos, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT: AMP,” “CONNECT,” “AMP,” “PORT,” and “SUB.” Other suitable playback devices may additionally or alternatively be used to implement the playback devices of example embodiments disclosed herein. Additionally, one of ordinary skill in the art will appreciate that a playback device is not limited to the examples described herein or to Sonos product offerings. In some embodiments, for example, one or more playback devices 110 include wired or wireless headphones (e.g., over-the-ear headphones, on-ear headphones, in-ear earphones, etc.). In other embodiments, one or more of the playback devices 110 include a docking station and/or an interface configured to interact with a docking station for personal mobile media playback devices. In certain embodiments, a playback device may be integral to another device or component such as a television, an LP turntable, a lighting fixture, or some other device for indoor or outdoor use. In some embodiments, a playback device omits a user interface and/or one or more transducers. For example, FIG. 1D is a block diagram of a playback device 110p including the input/output 111 and electronics 112 without the user interface 113 or transducers 114.

FIG. 1E is a block diagram of a bonded playback device 110q including the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q includes a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is a full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally includes other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 112h, and/or other playback device components. In certain embodiments, the NMD 120a includes an Internet of Things (IOT) device such as, for example, a thermostat, alarm panel, fire and/or smoke detector, etc. In some embodiments, the NMD 120a includes the microphones 115, the voice processing components 124, and only a portion of the components of the electronics 112 described above with respect to FIG. 1C. In some aspects, for example, the NMD 120a includes the processor 112a and the memory 112b (FIG. 1C), while omitting one or more other components of the electronics 112. In some embodiments, the NMD 120a includes additional components (e.g., one or more sensors, cameras, thermometers, barometers, hygrometers, etc.).

In some embodiments, an NMD can be integrated into a playback device. FIG. 1G is a block diagram of a playback device 110r including an NMD 120d. The playback device 110r can include many or all of the components of the playback device 110a and further include the microphones 115 and voice processing components 124 (FIG. 1F). The playback device 110r optionally includes an integrated control device 130c. The control device 130c can include, for example, a user interface (e.g., the user interface 113 of FIG. 1C) configured to receive user input (e.g., touch input, voice input, etc.) without a separate control device. In other embodiments, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyze the microphone data to determine whether a voice input is present in the microphone data. The voice input can include, for example, an activation word followed by an utterance including a user request. As those of ordinary skill in the art will appreciate, an activation word is a word or other audio cue signifying a user voice input. For instance, in querying the AMAZON VAS, a user might speak the activation word “Alexa.” Other examples include “Ok, Google” for invoking the GOOGLE VAS and “Hey, Siri” for invoking the APPLE VAS.

After detecting the activation word, voice processing components 124 monitor the microphone data for an accompanying user request in the voice input. The user request may include, for example, a command to control a third-party device, such as a thermostat (e.g., NEST thermostat), an illumination device (e.g., a PHILIPS HUE lighting device), or a media playback device (e.g., a SONOS playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partial schematic diagram of the control device 130a (FIGS. 1A and 1B). As used herein, the term “control device” can be used interchangeably with “controller” or “control system.” Among other aspects, the control device 130a is configured to receive user input related to the media playback system 100 and, in response, cause one or more devices in the media playback system 100 to perform an action(s) or operation(s) corresponding to the user input. In the illustrated embodiment, the control device 130a is a smartphone (e.g., an iPhone™, an Android phone, etc.) on which media playback system controller application software is installed. In some embodiments, the control device 130a may be, for example, a tablet (e.g., an iPad™), a computer (e.g., a laptop computer, a desktop computer, etc.), and/or another suitable device (e.g., a television, an automobile audio head unit, an IoT device, etc.). In certain embodiments, the control device 130a is a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 include one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can include data storage that can be loaded with one or more of the software components executable by the processor 132a to perform those functions. The software components 132c can include applications and/or other executable software code and/or instructions configured to facilitate control of the media playback system 100. The memory 132b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE, etc.). The network interface 132d can be configured, for example, to transmit data to and/or receive data from the playback devices 110, the NMDs 120, other ones of the control devices 130, one of the computing devices 106 of FIG. 1B, devices including one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection, etc.) from the control device 130a to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others. Additional description of zones and groups can be found below with respect to FIGS. 1I through 1M.

The user interface 133 is configured to receive user input and can facilitate control of the media playback system 100. The user interface 133 includes media content art 133a (e.g., album art, lyrics, videos, etc.), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year, etc.) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 includes a display presented on a touch screen interface of a smartphone (e.g., an iPhone™, an Android phone, etc.). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers include individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 may include, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound, etc.) and/or configured to facilitate filtering of background noise. Moreover, in certain embodiments, the control device 130a is configured to operate as a playback device and an NMD. In other embodiments, however, the control device 130a omits the one or more speakers 134 and/or the one or more microphones 135. For instance, the control device 130a may include a device (e.g., a thermostat, an IoT device, a network device, etc.) having a portion of the electronics 132 and the user interface 133 (e.g., a touch screen) without any speakers or microphones.

e. Suitable Playback Device Configurations

FIGS. 1I through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110m (e.g., a right playback device) to form Zone B. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110b and 110d can be merged to form a merged group or a zone group 108b. The merged playback devices 110b and 110d may not be specifically assigned different playback responsibilities. That is, the merged playback devices 110b and 110d may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1I, the playback devices 110l and 110m may be bonded so as to produce or enhance a stereo effect of audio content. In this example, the playback device 110l may be configured to play a left channel audio component, while the playback device 110m may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured to render low frequencies. When unbonded, however, the Front device 110h can be configured to render a full range of frequencies. As another example, FIG. 1K shows the Front and SUB devices 110h and 110i further bonded with Left and Right playback devices 110j and 110k, respectively. In some implementations, the Left and Right devices 110j and 110k can be configured to form surround or “satellite” channels of a home theater system. The bonded playback devices 110h, 110i, 110j, and 110k may form a single Zone D (FIG. 1M).

Playback devices that are merged may not have assigned playback responsibilities and may each render the full range of audio content the respective playback device is capable of. Nevertheless, merged devices may be represented as a single UI entity (e.g., a zone, as discussed above). For instance, the playback devices 110a and 110n in the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in subsequently referenced U.S. Pat. No. 10,499,146.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can be assigned a name such as “Dining+Kitchen”, as shown in FIG. 1M. In some embodiments, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some embodiments, the memory may store instances of various variable types associated with the states. Variable instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining +Kitchen zone group 108b and that devices 110b and 110d are grouped (FIG. 1L). Identifiers associated with the Kitchen may indicate the same or similar information by virtue of the Kitchen being part of the Dining +Kitchen zone group 108b. Other example zone variables and identifiers are described below.

In yet another example, the memory may store variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D andI, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. Pat. No. 10,712,997 filed Aug. 21, 2017, and titled “Room Association Based on Name,” and U.S. Pat. No. 8,483,853 filed Sep. 11, 2007, and titled “Controlling and manipulating groupings in a multi-zone media system.” Each of these patents is incorporated herein by reference in its entirety. In some embodiments, the media playback system 100 may not implement Areas, in which case the system may not store variables associated with Areas.

### III. Command Identification Absent Recognition of a Wake Word

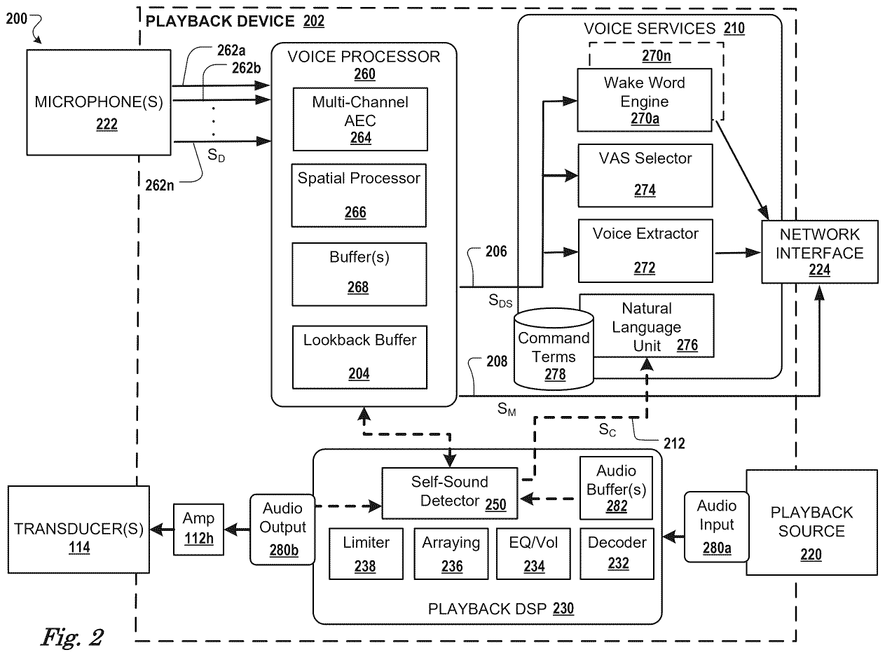

FIG. 2 is a functional block diagram showing a system 200 and playback device 202 configured to function, at least for a portion of its operation, in a wakewordless mode where speech-containing audio signals received from one of an array of microphones 222 (e.g., included in and/or external to the playback device 202) may be processed to identify voice input commands from a user. The playback device 202, for example, may represent one or more of the playback devices 110a-n of FIG. 1A, playback device 110p of FIG. 1D and/or FIG. 1E, and/or playback device 110r of FIG. 1G. The playback device 202 includes voice capture components (“VCC”, or collectively “voice processor 260”), at least one wake word engine 270, and at least one voice extractor 272, each of which is operably coupled to the voice processor 260. The system 200 further includes a set of microphones 222 and at least one network interface 224. The playback device 202 includes a playback digital signal processor (DSP) 230 (e.g., part of the audio processing components 112g of FIG. 1C). In further embodiments, the playback device 202 includes additional components, such as, in some examples, one or more audio amplifiers and/or media interfaces, which are not shown in FIG. 2 for purposes of clarity.

The microphones 222 of the system 200, in some embodiments, are configured to provide detected sound 262, S_{D}, from the environment of the playback device 202 to the voice processor 260. The detected sound S_{D} 262 may take the form of one or more analog or digital signals. In some implementations, the detected sound S_{D} 262 is composed of a collection of signals associated with respective channels 262a-n that are fed to the voice processor 260.

Each channel 262a-n of the detected sound 262 may correspond to a particular microphone 222. For example, a playback device such as the playback device 202 having six microphones may have six corresponding channels. Each channel of the detected sound S_{D} 262 may bear certain similarities to the other channels but may differ in certain regards, which may be due to the position of the given channel's corresponding microphone relative to the microphones of other channels. For example, one or more of the channels of the detected sound S_{D} 262 may have a greater signal to noise ratio (“SNR”) of speech to background noise than other channels.

As further shown in FIG. 2, in some embodiments, the voice processor 260 includes an acoustic echo canceller (“AEC”) 264, a spatial processor 266, and one or more buffers 268 (e.g., at least one audio signal buffer). In operation, the AEC 264, for example, receives the detected sound S_{D} 262 and filters or otherwise processes the sound to suppress echoes and/or to otherwise improve the quality of the detected sound S_{D} 262. That processed sound may then be passed to the spatial processor 266.

The spatial processor 266, in some embodiments, is configured to analyze the detected sound S_{D} 262 and identify certain characteristics, such as, in some examples, a sound's amplitude (e.g., decibel level), frequency spectrum, and/or directionality. In one respect, the spatial processor 266 may help filter or suppress ambient noise in the detected sound S_{D} 262 from potential user speech based on similarities and differences in the constituent channels 262a-n of the detected sound S_{D} 262. In one example, the spatial processor 266 may monitor metrics that distinguish speech from other sounds. Such metrics can include, in some examples, energy within the speech band relative to background noise and/or entropy within the speech band—a measure of spectral structure—which is typically lower in speech than in most common background noise. In some implementations, the spatial processor 266 determines a speech presence probability.

In some implementations, the processed sound S_{DS} 206 produced by the spatial processor 266 is provided to a voice services unit 210 (e.g., directly or via one or more buffers 268). A wake word engine 270 of the voice services unit 210, for example, may be configured to monitor and analyze received audio to determine if any wake words are present in the audio. The wake word engine 270 may analyze the received audio using a wake word detection process. If the wake word engine 270 detects a wake word, the playback device 202 may process voice input contained in the received audio. Example wake word detection processes accept audio as input and provide an indication of whether a wake word is present in the audio. Many first-and third-party wake word detection processes are known and commercially available. For instance, operators of a voice service may make their process accessible for use in third-party devices. Alternatively, a process may be trained to detect certain wake words.

In some embodiments, the wake word engine 270 runs multiple wake word detection processes 270a-n on the received audio simultaneously (or substantially simultaneously). Different voice services (e.g., AMAZON's Alexa®, APPLE's Siri®, MICROSOFT's Cortana®, GOOGLE'S Assistant, etc.), for example, each use a different wake word for invoking their respective voice service. To support multiple services, the wake word engine 270 may run the received audio through the wake word detection process 270a-n for each supported voice service in parallel. In such embodiments, the playback device 202 may include VAS selector components 274 configured to pass voice input to the appropriate voice assistant service. In other embodiments, the VAS selector components 274 may be omitted. In other embodiments, individual playback devices, including the playback device 202, may be configured to run different wake word detection processes 270a-n associated with particular VAS selector components 274. For example, the playback device 110e of the living room of FIG. 1A and FIG. 1M may be associated with AMAZON's ALEXA® and be configured to run a corresponding wake word detection process (e.g., configured to detect the wake word “Alexa” or other associated wake word), while the NMD of the playback device 110b in the Kitchen 101h of FIG. 1A and FIG. 1L may be associated with GOOGLE's Assistant, and be configured to run a corresponding wake word detection process (e.g., configured to detect the wake word “OK, Google” or other associated wake word).

In some embodiments, the playback device 202 includes speech processing components 276 (e.g., a speech processor or natural language processing (NLP) unit) configured to further facilitate voice processing. The speech processing components 276, for example, may perform voice recognition trained to recognize a particular user or a particular set of users associated with a household. Voice recognition software, for example, may implement voice-processing processes that are tuned to specific voice profile(s). The speech processing components 276, in some embodiments, are configured to determine the intent of the words of a command or uttered in correspondence with a command (e.g., keywords within background speech). The speech processing components 276 may reference a set of command terms 278. Each command term may include one or more keywords. For example, “volume” may be one keyword of a command term, while “lower volume” may be a command term having multiple (e.g., two) keywords. The command terms 278 may be stored to one or more databases including natural language processing terms, settings, and/or analytics for recognizing the command terms 278 in at least one language. In another example, the natural language unit 276 may include one or more machine learning processes, neural networks, and/or artificial intelligence networks trained to recognize the command terms 278 within vocalizations. The machine learning processes, neural networks, and/or artificial intelligence networks, for example, may be configured to process user inputs as feedback for adaptive learning to recognize the command terms 278. The input may be processed, for example, to determine an intent of the user based on the command terms 278. Intent may be determined, for example, when the confidence score for a given utterance or stream of utterances (e.g., a phrase) exceeds a given threshold value (e.g., 0.5 on a scale of 0-1, indicating that the given sound is more likely than not the keyword).

In some implementations, after processing the voice input, the natural language unit 276 provides input to a controller of the playback device 202, such as the control device 130a described in relation to FIG. 1H, to control the playback device 202 in accordance with the detected command term(s) 278. The natural language unit 276, for example, may recognize an instruction to perform one or more actions from the voice input. In some examples, based on the voice input, the natural language unit 276 may direct the control device 130a to initiate playback on the playback device 202, raise/lower volume, group/ungroup devices within a system, or turn on/off certain smart devices, among other actions.

In operation, in some embodiments, one or more buffers 268 capture data corresponding to the detected sound S_{D} 262 (e.g., at least one incoming audio stream). More specifically, the one or more buffers 268 may capture detected-sound data that was processed by the upstream AEC 264 and spatial processor 266.

In general, the detected-sound data form a digital representation (e.g., a sound-data stream), S_{DS} 206, of the sound detected by the microphones 222. In practice, the sound-data stream S_{DS} 206 may take a variety of forms. As one possibility, the sound-data stream S_{DS} 206 may be composed of frames, each of which may include one or more sound samples. The frames may be streamed (e.g., read out) from the one or more buffers 268 for further processing by downstream components, such as the wake word engine 270 and/or the voice extractor 272 of the voice services unit 210.

In some implementations, at least one buffer 268 captures detected-sound data utilizing a sliding window approach in which a given amount (e.g., a given window) of the most recently captured detected-sound data is retained in the at least one buffer 268 while older detected-sound data are overwritten when they fall outside of the window. For example, at least one buffer 268 may temporarily retain twenty frames of a sound specimen at a given time, discard the oldest frame after an expiration time, and then capture a new frame, which is added to the 19 prior frames of the sound specimen.

In some embodiments, when the sound-data stream S_{DS} 206 is composed of frames, the frames may take a variety of forms having a variety of characteristics. As one possibility, the frames may take the form of audio frames that have a certain resolution (e.g., 16 bits of resolution), which may be based on a sampling rate (e.g., 44,100 Hz). Additionally, or alternatively, the frames may include information corresponding to a given sound specimen that the frames define, such as metadata that indicates frequency response, power input level, signal-to-noise ratio, microphone channel identification, and/or other information of the given sound specimen. Thus, in some embodiments, a frame may include a portion of sound (e.g., one or more samples of a given sound specimen) and metadata regarding the portion of sound. In other embodiments, a frame may only include a portion of sound (e.g., one or more samples of a given sound specimen) or metadata regarding a portion of sound.

The voice processor 260, in some embodiments, includes at least one lookback buffer 204, which may be part of or separate from a memory used by the buffer(s) 268. In operation, the lookback buffer 204 can store sound metadata S_{M} 208 that is processed based on the detected-sound data S_{D} received from the microphones 222. The microphones 222 can include a collection of microphones arranged in an array. The sound metadata S_{M} 208 can include, for example: (1) frequency response data for individual microphones of the array, (2) an echo return loss enhancement measure (e.g., a measure of the effectiveness of the acoustic echo canceller (AEC) 264 for each microphone), (3) a voice direction measure; (4) arbitration statistics (e.g., signal and noise estimates for the spatial processing streams associated with different microphones); and/or (5) speech spectral data (e.g., frequency response evaluated on processed audio output after acoustic echo cancellation and spatial processing have been performed). Other sound metadata may also be used to identify and/or classify noise in the detected-sound data S_{D}. In at least some embodiments, the sound metadata S_{M} 208 may be transmitted separately from the sound-data stream S_{DS} 206, as reflected in the arrow extending from the lookback buffer 204 to the network interface 224. For example, the sound metadata S_{M} 208 may be transmitted from the lookback buffer 204 to one or more remote computing devices separate from the VAS 274 which receives the sound-data stream S_{DS} 206. In some embodiments, the sound metadata S_{M} 208 is transmitted to a remote server or cloud computing platform, for example for analysis to construct or modify a noise classifier.

In some implementations, media content from a playback source 220 (e.g., local audio source 105 as described in relation to FIG. 1C) is received at one or more signal processors of a digital signal processor (DSP) 230. The DSP 230, for example, may include a collection of audio processing circuitry and/or software processes (e.g., the audio processing components 112g of FIG. 1C) for processing an audio portion (e.g., audio input) 280a of the media content. Further, the audio processing circuitry and/or software processes (e.g., programs, code, and/or instructions) may be arranged as separate signal processor units (e.g., signal processors), each signal processor unit configured to process a separate channel of a multi-channel audio input received from the playback source 220. The audio processing circuitry and/or software processes can include one or more computer processors and/or separate audio processing circuitry, such as analog electronic circuit elements or separate electronic elements configured to carry out particular audio processing operations. The components of the playback DSP 230, in the illustrative example, include a decoder 232, an equalization/volume controller 234, an arraying processor 236, and a limiter 238. The playback DSP also includes a self-sound detector 250.

The input signal from the playback source 220 can be media content (e.g., audio content including music and/or other sounds) from a local or networked audio source. In one example, the audio input 280a may be a digital audio signal such as a packetized or non-packetized stream of audio from a music service or television, a digital audio file, an audio signal generated by the playback device 202 itself or a device connected to the playback device 202 (e.g., via a wired or wireless communication). For example, the packetized stream of audio may include 128 bits of audio data per packet. In another example, the audio signal from the playback source 220 may be an analog signal input from an auxiliary connection or a digital signal input from a USB connection. The audio input 280a may include frequency content that may range from 0 Hz to 22,050 Hz or some subset of this frequency range.

The decoder 232, in some embodiments, is configured to decode one or more audio formats such as, in some examples, Dolby and/or MP3. The equalizer/volume control 234 may include a user-adjusted volume control, user-adjusted treble and bass settings, and/or an equalizer. The array processor 236 may be configured to accommodate additional playback devices.

The limiter 238, in certain embodiments, can include various analog electrical circuit elements (e.g., capacitors, resistors, inductors) and/or digital filters that prevent the audio signal from exceeding a defined threshold. The limiter 238, for example, may be configured to attenuate an amplitude of the audio input 280a at one or more frequencies so that the playback device 202 continues to operate within its operational limit. The amount that the audio signal is reduced by the limiter 238 at any given moment is referred to herein as the “gain reduction” applied by the limiter 238. For example, if the limiter 238 received an audio signal 280a at 3 dB and output an audio signal 280b at 2 dB, then the gain reduction of the limiter 238 at that moment equals 1 dB. As audio signals are typically dynamic, the amount of gain reduction applied by the limiter 238 will generally vary over time.

In some implementations, the audio output 280b (e.g., a processed audio version of the audio signal 280a received from the playback source 220) is provided to the amplifier(s) 112h for amplification prior to broadcasting via the one or more transducers 114 (described in relation to FIG. 1C). The playback device 202, for example, may incorporate at least a portion of the transducers 114. In another example, at least a portion of the transducers 114 may be external to the playback device 202.

In some embodiments, the playback DSP 230 includes a self-sound detection unit (e.g., self-sound detector) 250 configured to differentiate between speech-containing audio signals originating from the audio output 280b provided to the transducers 114 and captured, upon broadcasting, by the microphones 222 and voice input of one or more individuals within the vicinity of the microphones 222. The self-sound detector 250, for example, may determine if the audio output 280b (e.g., as buffered by one or more audio buffers 282) contains a speech audio portion. Absent a speech audio portion within the audio output 280b, for example, any vocalization captured by the microphones 222 may be recognized as external voice signals (e.g., human utterances and/or other external vocalization content) that may be analyzed by the natural language unit 276. In this manner, the self-sound detector 260 may cue the natural language unit 276 to process the sound-data stream S_{DS} 206 for evidence of any of the command terms 278, regardless of whether a wake word has been recognized by the wake word engine 170. In illustration, the self-sound detection unit 250 may provide a speech signal to the natural language unit 276 indicating that the audio output 280b includes no speech content. Conversely, when a speech audio portion is identified within the audio output 280b, the self-sound detection unit 250 may provide a speech signal to the natural language unit 276 indicating that the audio output 280b does include vocalizations that may be misconstrued as command terms 278 spoken by a human near the playback device 202. Responsive to receipt of the speech signal indicating that the audio output 280b includes vocalizations, for example, the voice services unit 210 may rely on the wake word engine 270 to flag when the natural language unit 276 should analyze the sound-data stream SDS 206 for command terms 278. In further embodiments, the voice services unit 210 may suppress analysis of the sound data-stream S_{DS} 206 while the audio output 280b contains a speech portion (e.g., while the self-sound detector 250 asserts a speech content signal).

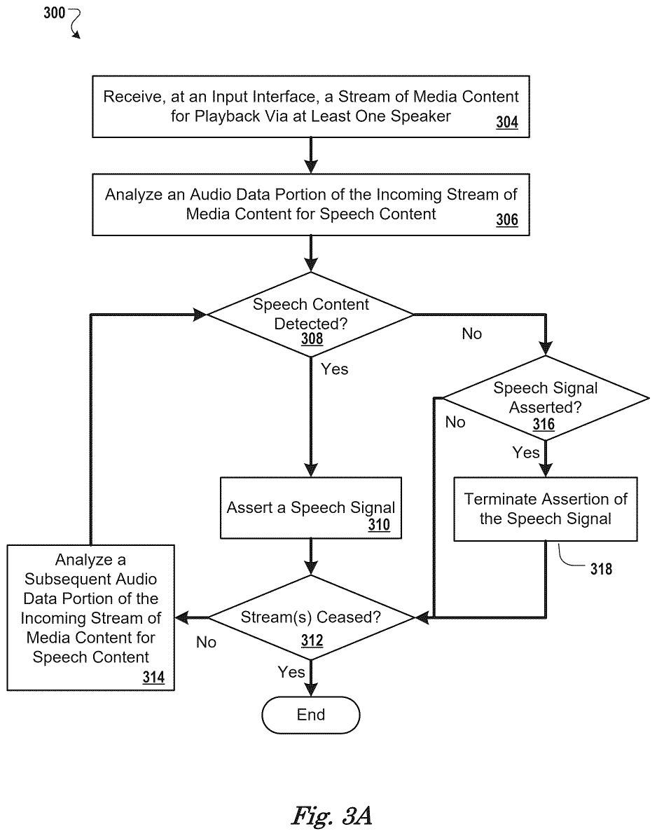

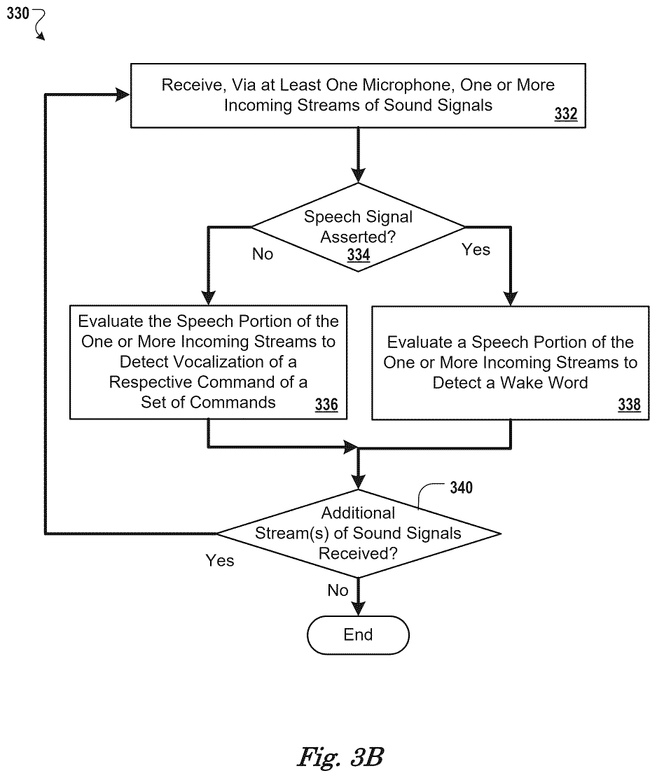

Turning to FIG. 3A, a flow chart illustrates an example method 300 for automatically flagging speech content within an audio portion of an incoming stream of media content. The method 300, for example, may be performed by the playback device 202 of FIG. 2. For example, the method 300 may automatically identify speech content in the audio input 280a, the audio output 280b, or an interim version thereof within the processing of the playback DSP 230.

In some implementations, the method 300 begins with receiving a stream of media content at an input interface (304). The media content may be provided for playback via at least one speaker. The media content, for example, may be the audio input 280a of FIG. 2 received from the playback source 220.

In some implementations, an audio data portion of the incoming stream of media content is analyzed for speech content (306). The self-sound detector 250 of FIG. 2, for example, may analyze at least an audio portion of the audio input 280a or the audio output 280b to identify one or more vocalizations. For example, the self-sound detector 250 may analyze the audio input 280 as buffered to one or more audio buffer(s) 282 (e.g., media signal buffer(s)). To identify a vocalization, in one example, an audio data portion of the incoming stream of media content may first be extracted from the stream of media content. The audio data portion of the incoming stream of media content may further be filtered to extract a portion of the media content including dialog. Absence of dialog, further to this example, may be indicative of lack of a vocalization within the audio data portion. Identifying the one or more vocalizations, in another example, may include analyzing a metadata portion of the media content to identify timings of dialog content. The dialog content, for example, may be flagged in part through subtitle metadata. In another example, machine learning analysis and/or an artificial intelligence network may analyze the audio data portion to recognize speech.

In some implementations, if speech content is detected (308), a speech signal is asserted (310). The speech signal, in some embodiments, is a hardware signal, such as a voltage switch on a logic chip input/output pin. In some embodiments, the speech signal is a software call to a receiving routine or program. The speech signal, in further embodiments, is a setting to a stored value, such as a variable used by multiple routines of a software program or by hardware-based operations encoded to a programmable logic device. Asserting the speech signal, for example, may establish a software setting, a stored data value, and/or a hardware voltage level that is maintained until such time as a termination signal replaces the assertion signal (e.g., the voltage level is reversed, the stored value is cleared, a termination command is issued, etc.). In another example, the speech signal is a transient state, such as a bit transferred within hardware logic to a receiving component. The speech signal, in another example, may include dialog content (e.g., at least a portion of an audio content portion of the media content). In other words, further to the example, if speech content is detected, the speech content may be directed for further processing.

In some embodiments, if the audio stream has ceased (312), the method 300 ends. If, instead, additional audio stream is received (312), a subsequent audio data portion of the incoming stream of media content is analyzed for speech content (314).

If, instead, no speech content is detected (308), in some implementations, if the speech signal was previously asserted (316), assertion of the speech signal is terminated (318). As described in relation to operation 310, in some examples, terminating assertion of the speech signal may involve reversing a voltage level, clearing a value stored to a non-transitory computer readable medium, or issuing a termination command to a software routine.

Although described in relation to a particular set of operations, in other embodiments, the method 300 includes more or fewer operations. In some examples, the method may include extracting the audio data portion from the incoming stream of media content and/or extracting a vocalization portion of the audio data. In further embodiments, certain operations of the method 300 are performed in a different order and/or concurrently. For example, the stream of media content may be received (304) concurrently with receipt of the incoming stream(s) of sound signals (302). Other modifications of the method 300 are possible.

FIG. 3B illustrates a flow diagram of an example method 330 for switching to wakewordless command recognition based on whether an audio portion of an incoming stream of media content contains speech content. The method 330, for example, may receive or recognize the assertion of the speech signal as provided by the method 300 of FIG. 3A. The method 330 may be performed, for example, by the voice services unit 210 of FIG. 2.

In some implementations, the method 330 begins with receiving, via at least one microphone, one or more incoming streams of sound signals (332). As described in relation to FIG. 2, for example, the incoming streams of sound signals may be the detected sound S_{D} 262 of channel 262a through channel 262n captured by the microphone(s) 222.

In some implementations, it is determined whether a speech signal has been asserted (334). The speech signal, for example, may be asserted as described in relation to the method 300 of FIG. 3A. The self-sound detector 250 of FIG. 2, for example, may assert the speech signal.

In some implementations, if a speech signal is not asserted (334), the speech portion of the one or more incoming streams of sound signals is evaluated to detect vocalization of a respective command of a set of commands (336). Absent assertion of the speech signal, for example, the voice services unit 210 of FIG. 2 may activate the natural language unit 276 (or a voice assistant service accessible via the network interface 224) to evaluate the sound-data stream S_{DS} 206 absent detection by the wake word engine 270 of a wake word. Absent recognition of a wake word, for example, a default voice assistant service (e.g., a VAS of the playback device 202 as provided by the voice services unit 210) may be configured to evaluate the sound-data stream S_{DS} 206 for the command terms 278.

If, instead, the speech signal is asserted (334), in some implementations, a speech portion of the one or more incoming streams is evaluated to detect a wake word (338). The evaluation, for example, may be performed as described in relation to the wake word engine 270 of FIG. 2.

In some implementations, as sound signals continue to be received (340), the method 330 continues to determine whether a speech signal has been asserted (334) and evaluate the speech portion of the one or more incoming streams of sound signals accordingly (336 or 338).

Although described in relation to a particular set of operations, in other embodiments, the method 330 includes more or fewer operations. For example, rather than evaluating the speech portion of the one or more incoming streams of sound signals to detect a wake word (338), when the speech signal is asserted (334), evaluation of the speech portion may be deactivated. In illustration, responsive to recognizing the speech signal from the self-sound detector 250, the voice services unit 210 may simply deactivate the natural language unit 276. In this manner, for example, there is no concern with the wake word engine 270 misconstruing the intent of the user due to competing incoming speech signals and thereby interrupting the user's enjoyment of the media content. Other modifications of the method 330 are possible.

Returning to FIG. 2, in some implementations, the self-sound detector unit 250 is configured to suppress or remove at least a speech portion of the audio output 280b from one or more channels of the detected sound S_{D} 262 to provide a distilled (e.g., cleaned) version Sc 212 of the sound-data stream S_{DS} 206 for analysis by the natural language unit 276. In this circumstance, in some embodiments, the voice services unit 210 lacks the wake word engine 270, the VAS selector 274, and/or the voice extractor 272. The playback device 202 may instead rely on the natural language unit 276 for recognizing the command terms 278 in all circumstances. In other embodiments, the playback device 202 may only use the wake word engine 270 based on a user setting option.

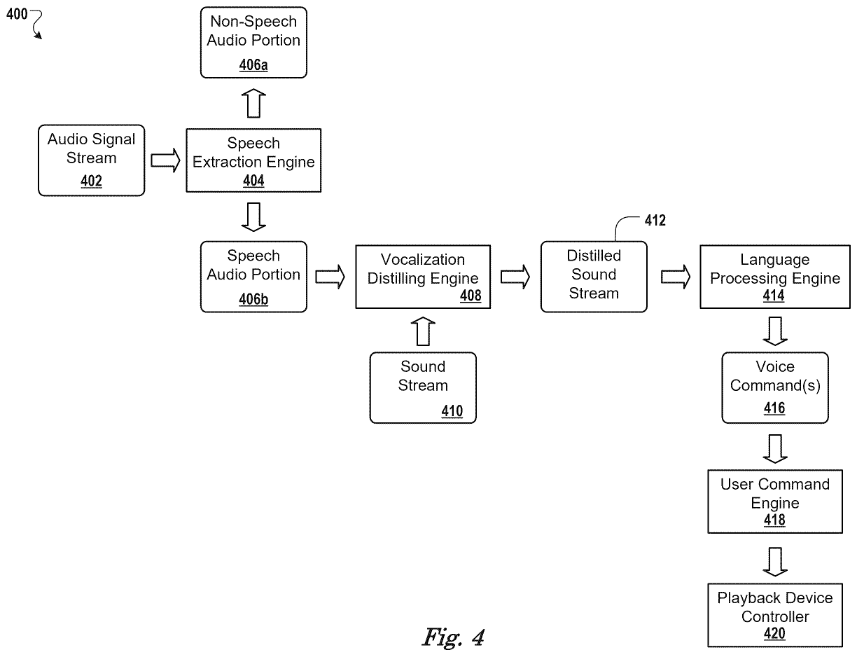

Turning to FIG. 4, a flow diagram illustrates an example process 400 for analyzing an audio signal stream 402 captured by a microphone to automatically differentiate audio recently output by a playback device from the microphone's capture of vocalizations within a vicinity of the media playback. The process 400, for example, may be performed at least in part by the playback device 202 of FIG. 2. For example, the playback device 202 may automatically differentiate at least a subset of the audio output 280b recently output to the transducer(s) 114 (e.g., as temporarily stored in the audio buffer(s) 282) from sound signals recently captured by the microphone(s) 222 and buffered in the buffer(s) 268 of the voice processor 260. The various engines of the process 400, in some embodiments, are configured as software routines or processes (e.g., at least a portion of a software program) coded as instructions for executing on processing circuitry, such as one or more processors. Certain engines or operations performed by certain engines, in some embodiments, are configured as hardware logic (e.g., hardware-based operations) hard-coded or programmed into processing circuitry, such as, in some examples, a programmable logic chip or other programmable logic device, an application-specific integrated circuit (ASIC), or a customized processor device.

In some implementations, the process 400 begins with receiving, at a speech extraction engine 404, the audio signal stream 402. The audio stream, for example, may be the audio input 280a received by the playback DSP 230 of FIG. 2. The speech extraction engine 404, for example, may be configured as part of the playback DSP 230 or the voice services unit 210 of FIG. 2.

In some implementations, the speech extraction engine 404 recognizes, within the audio signal stream 402, a speech audio portion 406b. The speech audio portion 406b, for example, may be recognized at least in part as described in relation to the operation 306 of the method 300 of FIG. 3A. The speech audio portion 406b, for example, may be stored to a temporary buffer or high-speed memory region for future processing, such as the buffer(s) 268 of FIG. 2.

The speech extraction engine 404, in some implementations, separates the speech audio portion 406b from the audio signal stream 402. The audio signal stream 402, for example, may be a mixed audio soundtrack for playback in coordination with displayed video content. In another example, the audio signal stream 402 may be an audio narration (e.g., a podcast, a radio morning show, etc.) including both speech audio data and non-speech audio data (e.g., background sound content). Isolating the speech audio portion 406b, in some examples, may be performed by the voice processor unit 260 or the voice services unit 210 of the playback device 202 of FIG. 2. In another example, the speech audio portion 406b may be isolated by the playback DSP 230 (e.g., the self-sound detector 250) using audio signals temporarily stored by the buffer(s) 268 of the voice processor 260. In certain embodiments, the speech extraction engine 404 separates the audio signal stream 402 into a non-speech audio portion 406a and a speech audio portion 406b. For example, the speech extraction engine 404 may use the non-speech audio portion 406a for dialogue enhancement purposes, in some examples by effectively reducing the volume of the non-speech audio portion 406a or otherwise adjusting the output of the non-speech audio portion 406a (e.g., within at least a portion of the speech frequency range) to increase relative clarity or volume of the speech audio portion 406b. This is described, for example, in U.S. Provisional Patent Application Ser. No. 63/700,280 entitled “Techniques for Speech Enhancement” and filed Sep. 27, 2024, the contents of which is hereby incorporated by reference. The audio signal stream 402 may be divided, for example, through frequency analysis (e.g., separating sound within a speech frequency range from sound outside of a range of speech frequencies). The audio signal stream 402, in another example, may be divided by using automatic speech recognition (ASR) analysis, confirming that the sounds within the speech frequency range correspond to recognizable verbalizations (e.g., according to natural language processing as performed, for example, by the natural language unit (NLU) 276 of FIG. 2). In another example, a metadata portion of the sound (e.g., sound metadata S_{M} 208 of FIG. 2) may be used to find instances of speech and separate them from non-speech components of the audio signal stream 402. In another example, one or more machine learning classifiers trained in recognizing speech patterns within audio content are applied to the audio signal stream 402 to identify the speech audio portion 406b. The machine learning classifier(s), for example, may be applied on a frame-by-frame basis to the audio signal stream 402, such that the self-sound detector 250 of FIG. 2 may adaptively, in real-time, provide wakewordless command capability to the playback device 202. While illustrated as two separate signals, the non-speech audio portion 406a and the speech audio portion 406b may be included in the same digital output (e.g., including flags or markers differentiating the speech component from the non-speech component). In another example, the non-speech audio portion 406a may be created as a logical inversion of the speech audio portion 406b or vice-versa.

In some embodiments, as described in greater detail in related This is described, for example, in U.S. Provisional Patent Application Ser. No. 63/700,280 entitled “Techniques for Speech Enhancement” and filed Sep. 27, 2024, the speech extraction engine 404 operates in the frequency domain to separate speech content from non-speech content. For example, a short-time Fourier transform (STFT) may be applied to the audio signal stream 402 to produce a corresponding input frequency spectrum. In the digital domain, the input frequency spectrum may be represented as a two-dimensional matrix of signal magnitude and frequency. The audio signal stream 402 may be divided into a set of frequency bins (e.g., 256, 512, etc.) and the signal magnitude in each frequency bin may be recorded as a digital value. The speech extraction engine 404 may identify the speech audio portion 406b within the input frequency spectrum matrix by categorizing the frequency bins of the two-dimensional matrix as “speech” or “no speech,” in a binary fashion, for example producing a speech audio portion 406 represented by a matrix of signal magnitude, frequency, and speech/no-speech flag (e.g., a logical one or zero).

In some implementations, a vocalization distilling engine 408 obtains the speech audio portion 406b of the audio signal stream 402 as well as a sound stream 410 containing audio captured by one or more microphones within a vicinity of the playback of the audio signal stream 402. For example, the sound stream 410 may be the processed sound S_{DS} 206 or detected sound S_{D} 262 of FIG. 2. The sound stream 410, in another example, may have previously been separated into a speech sound portion and an audio sound portion, similar to the division of audio performed by the speech extraction engine 404.

In some embodiments, the vocalization distilling engine 408 uses the speech audio portion 406b to filter out, mask, or otherwise remove verbalizations within the audio signal stream 402 from the sound stream 410, producing a distilled sound stream 412. The vocalization distilling engine 408, for example, may align the speech audio portion 406b with the sound stream 410 in accordance with a broadcast timing of the audio signal stream 402 such that the timeframe of capture of the sound stream 410 aligns with playback of the speech audio portion 406b. The timing, for example, may be obtained from the buffer(s) 268 or lookback buffer 204 of the voice processor 260 of FIG. 2. The playback timing of the audio signal stream 402, for example, may be obtained from the playback DSP 230 of FIG. 2. The distilled sound stream, for example, may be stored to a temporary buffer or high-speed memory region for future processing. The distilled sound stream may be considered to be an external audio signal containing external voice content (e.g., external to the playback device and lacking most if not all vocalizations originating from any media content broadcast by the playback device).

In some embodiments, further to the example described above, the vocalization distilling engine 408 applies the matrix of the speech audio portion as a speech mask for masking (e.g., removing) the speech portion 206b from the sound stream 410. In an illustrative example, if the speech “bins” of the matrix are marked with a speech flag of logical zero, multiplying the input frequency spectrum representation of the SDS 206 by the matrix produces the distilled sound stream 412 from which the speech content has largely been eliminated.

In some implementations, a language processing engine 414 obtains the distilled sound stream 412 and detects, within the distilled sound stream 412, any vocalization (utterance) corresponding to a voice command, such as one or more voice commands 416. The natural language unit 276 of FIG. 2, for example, may obtain the distilled sound stream 412 created by the self-sound detector 250. The voice commands 416, for example, may include one or more of the command terms 278 described in relation to FIG. 2. Further, the language processing engine 414 may analyze the voice command(s) 416 as well as utterances received after the voice command(s) 416 were spoken (e.g., a subsequent portion of the audio signal stream 402, distilled by the vocalization distilling engine 408 or bypassed directly to the language processing engine 414, and containing additional external vocalization content) to recognize an intent corresponding to the command (e.g., one or more actions associated with the command term, context such as a title of media content, etc.). For example, the command term “volume” may be uttered prior to one or more subsequent vocalizations identifying a direction (e.g., up or down). The intent, in this example, may correspond to adjusting the playback volume of content presently streamed by the playback device 202.

In some implementations, the voice command(s) 416, as well as in some circumstances terms associated with an intent of the voice command terms, are used by a user command engine 418 to cause performance of the issued command. The user command engine 418, for example, may translate the voice command(s) (e.g., natural language terms extracted by the language processing engine 414) into signals or digital commands used by a playback device controller 420 to control performance of the playback device. For example, the control device 130a described in relation to FIG. 1H may control the playback device 202 in accordance with the signals or digital commands provided by the user command engine 418.

Although described in relation to a particular set of operations, in other embodiments, the process 400 may include more or fewer operations. For example, the speech extraction engine 404 may only produce a speech audio portion 406b (e.g., a speech mask) rather than dividing the audio signal stream 402 into two portions of audio data 406a, 406b. In another example, the speech extraction engine 404 of a local playback device may communicate with a network-enabled machine learning analysis system for separating the speech audio portion 406b from the non-speech audio portion 406a according to one or more trained machine learning classifiers.

The process 400 is described as a particular series of operations. In other embodiments, certain operations of the process 400 may be performed in a different order and/or concurrently. For example, the speech extraction engine 404 and vocalization distilling engine 408 may execute in an ongoing fashion, concurrently processing different sections of the incoming audio signal stream 402, while the language processing engine 414 may recognize and collect, from the incoming distilled sound stream 412, a series of utterances to identify the voice command(s) 416. Other modifications of the process 400 are possible.

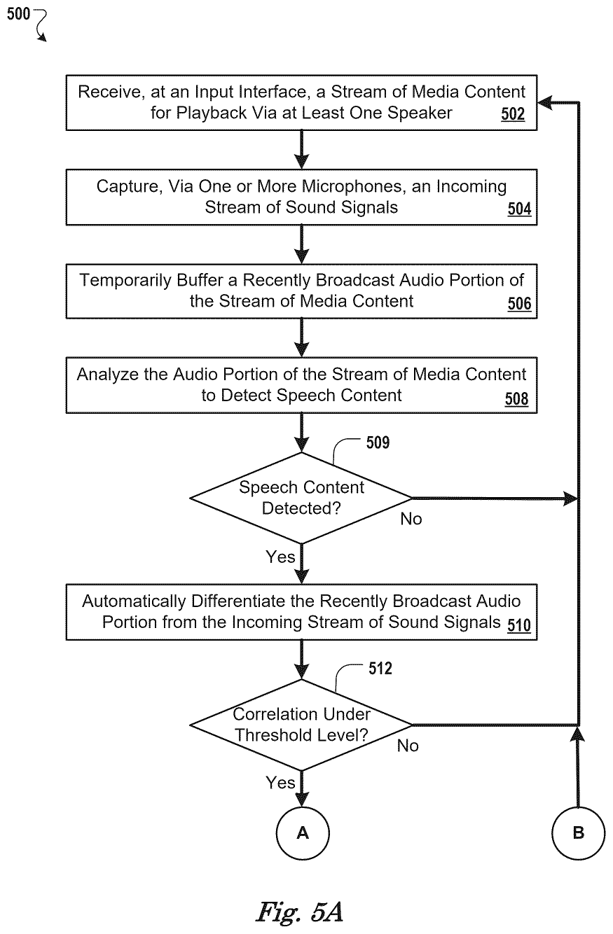

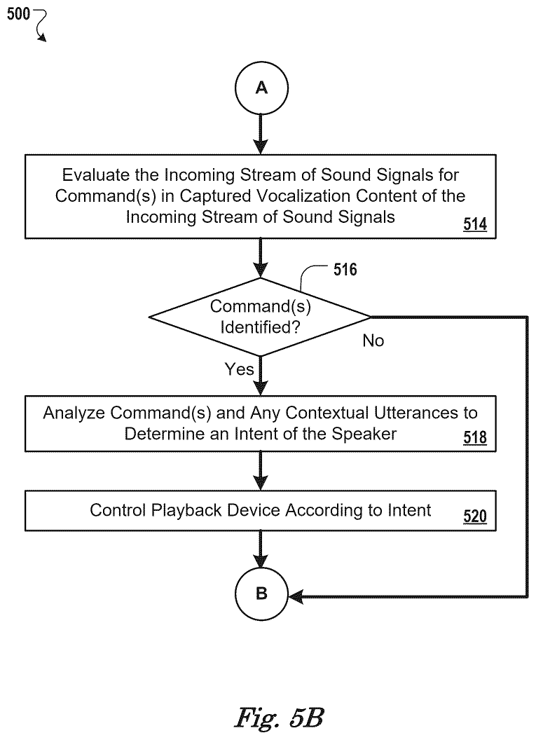

FIG. 5A and FIG. 5B illustrate a flow chart of an example method 500 for recognizing voice command interactions of a user of a playback device without reliance on a wake word. The method 500 may be performed at least in part on a playback device, such as one or more of the playback devices 110a-n of FIG. 1A, playback device 110p of FIG. 1D and/or FIG. 1E, playback device 110r of FIG. 1G, and/or the playback device 202 of FIG. 2. Portions of the method 500, for example, may be performed by the speech extraction engine 404, the vocalization distilling engine 408, the language processing engine 414, the user command engine 418, and/or the playback device controller 420 of the process 400 of FIG. 4.

Turning to FIG. 5A, in some implementations, the method 500 begins with receiving, at an input interface, a stream of media content for playback via at least one speaker (502). The stream of media content, for example, may be the audio signal stream 402 received by the speech extraction engine 404 of the process 400 of FIG. 4. The stream of media content, for example, may be received as described in relation to operation 304 of the method 300 of FIG. 3 (e.g., the audio input 280a received by the playback DSP 320 of the playback device 202 of FIG. 2).

In some implementations, one or more microphones capture an incoming stream of sound signals (504). The microphones, for example, may be the microphone(s) 222 of the system 200 of FIG. 2. The incoming stream of sound signals, for example, may be received as describe in operation 332 of the method 330 of FIG. 3. The incoming stream of sound signals, for example, may be the sound stream 410 received by the vocalization distilling engine 408 of the process 400 of FIG. 4.

In some implementations, a recently broadcast audio portion of the stream of media content is temporarily buffered (506). The recently broadcast audio portion, for example, was recently broadcast via one or more transducers in a vicinity of the one or more microphones. The recently broadcast audio portion, for example, may be buffered by the audio buffer(s) 282 of the playback DSP 230 of FIG. 2. The one or more transducers, for example, may be the transducer(s) 114 of FIG. 2.

In some implementations, the audio portion of the stream of media content is analyzed to detect speech content (508). As described in relation to the speech extraction engine 404 of the process 400 of FIG. 4, for example, the audio signal stream 402 may be analyzed to identify the speech audio portion 406b. In another example, the audio portion of the stream of media content may be analyzed as described in relation to operation 306 of the method 300 of FIG. 3.

In some embodiments, machine learning techniques are applied to identify speech content in the audio portion of the stream of media content. The machine learning techniques may be applied on the recently broadcast audio portion in its original format (e.g., as a time-domain signal) or in a converted format (e.g., as a frequency spectrum data stream). The machine learning techniques, for example, may be applied prior to and/or concurrently with broadcast of the audio portion of the stream of media content. For example, the machine learning techniques may be applied concurrently with at least a portion of the operations performed by the playback DSP 230, as described in relation to FIG. 2, to automatically recognize speech signals within the audio input 280a while it is being prepared for broadcast as the audio output 280b. The machine learning techniques, for example, may be used to produce a speech mask for applying to the stream of sound signals to mask the vocalizations captured by the one or more microphones from the broadcast of the stream of media content. Differentiating the recently broadcast audio portion from the incoming stream of sound signals, in this scenario, may include applying the speech mask to the incoming stream of sound signals.

The machine learning techniques, in some embodiments, include one or more parametric machine learning processes (e.g., configured as at least one parameterized machine learning model) trained to identify speech in the audio portion of an incoming stream of media content by reducing the identification of speech within audio to a simplified function having a controlled set of coefficients (e.g., parameters). The parametric machine learning process(s), in some examples, may enable high speed analysis of the incoming stream of media content (e.g., in real time or near-real time) by reducing the complexity of the analysis. The parameters of the parametric machine learning process(s), for example, may yield a generalized function capable of predicting whether or not speech is likely present in a current frame of the input signal. The likelihood, in some examples, may be represented as a confidence level or metric (e.g., percentage or absolute value) of how likely the input represents audio including speech, or an uncertainty level or metric (e.g., percentage or absolute value) representing how likely the machine learning process is correct in its determination regarding whether or not the particular input (e.g., frame) contains speech.

In some embodiments, the parameterized machine learning model includes a neural network, such as a deep neural network (DNN) model or an artificial neural network (ANN) model. In further examples, the parameterized machine learning model may be a recurrent neural network (RNN), a convolutional neural network (CNN) model, a Gaussian mixture model (GMM), or a hidden Markov model (HMM). The various options for machine learning techniques are described in greater detail, for example, in relation to U.S. Provisional Patent Application Ser. No. 63/700,280 entitled “Techniques for Speech Enhancement” and filed Sep. 27, 2024.

If speech content is detected (509), in some implementations, the recently broadcast audio portion is automatically differentiated from the incoming stream of sound signals (510). As described in relation to the process 400 of FIG. 4, for example, the vocalization distilling engine 408 may differentiate the speech audio portion 406b from the sound stream 410, thereby producing the distilled sound stream 412. In an example, based on one or more machine learning processes detecting likelihood of speech content, a subset of the recently broadcast audio portion of the stream of media content within a frequency range of verbalizations may be extracted and converted into a mask for differentiating from the incoming stream of sound signals. Techniques for creating a mask from a speech audio portion of the recently broadcast audio, for example, are described in detail in relation to U.S. Provisional Patent Application Ser. No. 63/700,280 entitled “Techniques for Speech Enhancement” and filed Sep. 27, 2024. In a further example, a voice activity detector may compare full-band audio content 402 to the sound stream 410 determine a likelihood of a false positive.

If, instead, no speech content is detected (509), the method 500 may return to receiving a subsequent stream of media content (502).

If a correlation between the recently broadcast audio portion and the incoming stream of sound signals is above a threshold level (512), in some implementations, the method 500 returns to receiving subsequent media content (502). A high correlation between the recently broadcast audio portion and the incoming stream of sound signals (e.g., within a frequency range of vocalizations), for example, demonstrates that a majority if not all speech content within the incoming stream of sound signals originated from the streaming media content. In this circumstance, it may be reasonable to assume that that the remainder of the incoming stream of sound signals is unlikely to contain user commands and/or any user command therein would have been obscured by overlapping voice content within the streaming media content. The threshold level, in some examples, may be set to over 50%, at least 70%, or at least 80%.

If the correlation, instead, is less than the threshold level (512), turning to FIG. 5B, in some implementations, the incoming stream of sound signals is evaluated to identify one or more commands in captured vocalization content of the incoming stream of sound signals (514). The incoming stream of sound signals, for example, may be evaluated in the form of the distilled sound stream 412 by the language processing engine 414, as described in relation to the process 400 of FIG. 4. For example, the natural language unit 276 of FIG. 2 may apply natural language processing analysis to evaluate the incoming stream of sound signals to identify one or more of the command terms 278.

If one or more commands are identified in the incoming stream of sound signals (516), in some implementations, the command(s) and any contextual utterances are analyzed to determine an intent of the speaker (518). For example, the user command engine 418 of FIG. 4 may analyze the commands to determine the intent of the speaker. The contextual utterances, for example, may be included in the same incoming stream of sound signals captured at operation 504 (e.g., in between command terms) or in a subsequent portion of the incoming stream of sound signals (e.g., subsequent external audio signals).

If, instead, no command was identified (516), in some implementations, the method 500 returns to receiving subsequent media content (502).

In some implementations, a playback device is controlled according to the determined intent (520). For example, the playback device 202 of FIG. 2 may be controlled according to the determined intent. The playback device controller 420 of FIG. 4, for example, may control the playback device.

The method 500, in some implementations, continues to process the stream of media content in real time or near-real time as it is received.

Although described in relation to a particular set of operations, in other embodiments, the method 500 includes more or fewer operations. For example, in some embodiments, upon detecting the speech content (508) using one or more machine learning processes, the confidence metric/uncertainty metric provided by the machine learning model(s) may be used to assert the speech signal (310) as described in relation to the method 300 of FIG. 3. Additionally, although the method 500 is described as a particular series of operations, in other embodiments, certain operations of the method 500 may be performed in a different order and/or concurrently. For example, while the operations of the method 500 are described for sake of simplicity as being performed in series, in practice, each of the operations of at least the receiving (502), the capturing (504), the buffering (506), the analyzing (508), and the differentiating (510) would generally be performed concurrently, for example as a concurrent pipeline of operations applied on a frame-by-frame basis as the incoming stream of sound signals and the stream of media content are received. Other modifications of the method 500 are possible.

### IV. Conclusion

The above discussions relating to audio processing for wakewordless command identification provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

Additionally, references herein to “embodiment” means that a particular element, structure, or characteristic described in connection with the embodiment can be included in at least one example embodiment disclosed herein. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A system comprising:
at least one microphone;
at least one speaker; and
a playback device comprising
an audio signal buffer configured to store at least one incoming stream of sound signals captured by the at least one microphone,
an input interface configured to receive an incoming stream of media content,
one or more signal processors configured to output an audio data portion of the incoming stream via one or more speakers of the at least one speaker,
a voice services unit configured to
detect, in real-time, a speech signal, and
evaluate, in absence of the speech signal, the at least one incoming stream to detect vocalization of a respective command of a set of commands, and
a self-sound detection unit configured to
detect a vocalization within the audio data portion, and
based on detecting the vocalization, communicate, in real-time corresponding to the one or more signal processors outputting the vocalization, the speech signal to the voice services unit.

2. The system of claim 1, wherein the respective command is a first keyword of a vocalization comprising multiple keywords.

3. The system of claim 1, wherein, in presence of the speech signal, the voice services unit is configured to deactivate detecting vocalizations.

4. The system of claim 1, wherein the voice services unit is configured to evaluate the at least one incoming stream to detect vocalization of a wake word, wherein the set of commands is different than the wake word.

5. The system of claim 1, wherein, responsive to the speech signal, the self-sound detection unit is configured to automatically differentiate at least a subset of the audio data portion recently output to the at least one speaker from the at least one incoming stream of sound signals buffered by the audio signal buffer to identify external vocalization content.

6. The system of claim 5, wherein the self-sound detection unit is configured to, while the speech signal is communicated, continue to automatically differentiate to identify additional external vocalization content.

7. The system of claim 6, wherein the self-sound detection unit is configured to communicate a termination signal terminating assertion of the speech signal.

8. The system of claim 5, wherein the voice services unit is configured to, based at least in part on detecting the vocalization of the respective command, activate a natural language unit (NLU), wherein in the NLU is configured to analyze subsequent vocalizations in subsequent external audio signals produced by the self-sound detection unit to determine an intent associated with the vocalization.

9. The system of claim 8, wherein the playback device comprises the NLU.

10. The system of claim 5, wherein the self-sound detection unit is configured to extract, in real-time from the at least one incoming stream of sound signals buffered by the audio signal buffer, at least a subset of an audio portion of the incoming stream of media content, thereby producing an external audio signal.

11. The system of claim 10, wherein the speech signal comprises the subset of the audio portion.

12. The system of claim 10, wherein:
the incoming stream of media content comprises dialog; and
extracting the subset of the audio portion of the incoming stream of media content comprises extracting the dialog from the at least one incoming stream of sound signals.

13. The system of claim 5, further comprising:
a media signal buffer configured to temporarily store an audio portion of an incoming stream of media content;
wherein the voice services unit is configured to divide the audio portion of the incoming stream of media content into a speech audio data and a non-speech audio data, and
wherein the self-sound detection unit is activated to differentiate the audio portion of the incoming stream of media content from the at least one incoming stream of sound signals based on the audio portion of the incoming stream of media content including the speech audio data.

14. The system of claim 13, wherein differentiating the audio portion of the incoming stream of media content comprises correlating the speech audio data with the at least one incoming stream of sound signals.

15. The system of claim 14, wherein, responsive to the self-sound detection unit identifying less than a threshold level of correlation between the speech audio data and the at least one incoming stream of sound signals, an automatic speech recognition (ASR) unit is activated to evaluate the external vocalization content.

16. The system of claim 13, wherein differentiating the audio portion of the incoming stream of media content comprises applying the speech audio data frame-by-frame to the at least one incoming stream of sound signals to mask the speech audio data from each stream of the at least one incoming stream of sound signals.

17. The system of claim 1, wherein a first speaker of the at least one speaker comprises one or more microphones of the at least one microphone.

18. The system of claim 1, wherein the playback device comprises one or more microphones of the at least one microphone.

19. The system of claim 1, wherein the playback device comprises one or more speakers of the at least one speaker.

20.-40. (canceled)

41. The system of claim 1, wherein detecting the speech signal comprises identifying, in the incoming stream of media content, metadata flagging a segment of the audio data portion containing speech content.

42.-56. (canceled)
